(19) United States
(12) Patent Application Publication
(10) Pub. No.: US 2002/0047055 A1
(43) Pub. Date: Apr. 25, 2002

(54) Fuel injection valve

(76) Inventors: Mamoru Matsubara, Obu-shi (JP); Kazuhiro Yoneshige, Obu-shi (JP); Atsushi Okada, Obu-shi (JP)

Correspondence Address: Arent Fox Kintner Plotkin & Kahn PLLC, 1050 Connecticut Avenue N W, Suite 600, Washington, DC, 20036-5339, US

(21) Appl. No.: 09/537,388

(22) Filed: Mar. 29, 2000

(30) Foreign Application Priority Data
May 14, 1999 (JP) HEI 11-134939

(51) Int. Cl. F02M 61/10

(52) U.S. Cl. 239/585.5; 239/533.2; 239/533.9; 239/533.11

(57) ABSTRACT

This fuel injection valve is provided in a body thereof with a needle valve so that the needle valve can be moved in the axial direction and inclined by an angle of inclination of θ₁ with respect to the axis of the body, and with stopper plates with which a stopper portion of the needle valve is engaged when the valve is opened, and an angle of inclination θ₂ with respect to a perpendicular plane crossing the axis of the needle valve at right angles thereto is given between the stopper portion and stopper plates. The angle of inclination θ₂ between the stopper portion and stopper plates is set to be larger than that θ₁ in the axial direction of the needle valve, and the stopper portion is formed so that a ratio D₁/D₀ of an outer diameter D₁ of the stopper portion of the needle valve to an inner diameter D₀ of an inner chamber of the body becomes 0.6 to 1.1. This enables the bouncing time at the valve opening time to be shortened, the linearity of the fuel injection characteristics to be improved, a delay in the valve closing time at the time of closing the valve to be reduced, and the increasing of the speed and responsibility of fuel injection to be attained.

### BACKGROUND OF THE INVENTION

1. Field of the Invention

This invention relates to an electromagnetic fuel injection valve used for an internal combustion engine, and more particularly to a fuel injection valve capable of improving the performance characteristics of fuel injection.

2. Description of the Related Art

An electromagnetic fuel injection valve used for an internal combustion engine is formed generally by fixing a fuel joint pipe to an upper portion of a body, providing in the body an electromagnetic solenoid and a movable core moved slidingly in the vertical direction by the electromagnetic solenoid, fixing a needle valve to a lower end of the movable core, and providing a nozzle body on a lower portion of the body so as to enclose the needle valve therewith. Furthermore, an insert pipe is inserted in the fuel joint pipe, and a coiled spring is provided between this insert pipe and movable core, the coiled spring urging the movable core toward a free end of the body, i.e., in the needle valve closing direction. The nozzle body is fixed to a free end portion of the body so as to enclose a free end portion of the needle valve, and a flange-like stopper portion provided at a base section of the needle valve engages stopper plates, which are provided at an upper portion of the nozzle body, when the valve is opened, a valve disc at a free end portion of the needle valve engaging a valve seat of the nozzle body when the valve is closed.

The movements of the needle valve during the opening and closing of the same valve are guided by sliding portions of the valve disc and an upper section of the valve seat, and a sliding guide portion provided between an outer circumferential surface of the movable core fixed to an upper end of the needle valve and an inner circumferential surface of a sleeve fixed to a free end of the fuel joint pipe. When a clearance between these upper and lower sliding guide portions is large, the inclination of the needle valve during an operation thereof increases, and the planar contacting of the valve disc or stopper portion cannot thereby be effected, so that this part is squeezed. Consequently, the bouncing of the needle valve occurs when it is opened, and a delay occurs in an operation of the needle valve when it is closed, this causing the performance characteristics of a fuel injection operation to be deteriorated.

Under the circumstances, the applicant of the present invention proposed in Japanese Patent Laid-Open No. 274128/1998 a fuel injection valve formed by establishing the relation in which a clearance C₁ at a sliding guide portion of a free end section of a needle valve is set smaller than that C₂ at a sliding guide portion of a base section thereof, i.e., setting C₁, C₂ to C₁<C₂; and giving thereby a very small angle of inclination θ₁ to the needle valve so that a surface of a flange-like stopper portion at a base section of the needle valve and those of stopper plates which contact each other when the valve is opened are put in a sulistantially linearly contacting state and thereby minimizing the bouncing of the needle valve, whereby it is rendered possible to reduce a minimum fuel injection rate to a low level and widen a dynamic range in the injection performance characteristics when a pulse width of a valve opening pulse signal is reduced.

However, in the fuel injection valve of the above-described structure, a surface of the flange-like stopper portion at the base section of the needle valve and surfaces of the stopper plates which contact each other when the valve is opened are put in a substantially linearly contacting state, whereby a large squeezing force is made to occur when the valve is opened and the valve opening bounce can be reduced. However, when the valve is closed, i.e., when the free end portion of the valve disc of the needle valve engages the valve seat to cause the stopper portion and stopper plates to be separated from each other, a so-called inverse squeeze in which the stopper and stopper plates work so as to be adsorbed to each other occurs on a large scale. This causes a long delay to occur in a valve closing operation. Namely, the practical valve opening time is lengthened as compared with the pulse width of a valve opening pulse signal, and it is difficult to attain an accurate fuel injection rate corresponding to the pulse width of a valve opening pulse signal.

### SUMMARY OF THE INVENTION

The present invention has been made in view of the above circumstances, and provides a fuel injection valve capable of reducing a delay of the valve closing time after the termination of a valve opening pulse signal by reducing the bouncing time at the needle valve opening time, and suitably reducing the inverse squeeze which works between the stoppers of the needle valve when the valve is closed.

The present invention is directed to a fuel injection valve provided with a needle valve in a body so that the needle valve can be moved axially and inclined with respect to the axis of the body by an angle of inclination θ₁, and fixed members on the body which the stopper portion on the side of the needle valve engages when the valve is opened, an angle of inclination θ₂ with respect to a perpendicular plane crossing the axis of the needle valve at right angles thereto being given between the stopper portion and fixed members, wherein the stopper portion is formed so that the angle of inclination θ₂ between the stopper portion and fixed members is set larger than that θ₁ in the axial direction of the needle valve with a ratio D₁/D₀ of an outer diameter D₁ of the stopper portion on the side of the needle valve to an inner diameter D₀ of an inner chamber of the body becoming 0.6 to 1.1.

In the fuel injection valve of such a structure, the stopper portion of the needle valve engages the fixed members of the body to put the valve in an opened state. At this time, the engaged condition of the stopper portion is a linearly contacting condition since the contact surface of the stopper portion and those of the fixed portions are formed so that the relation between the angles of inclination θ₁, θ₂ becomes θ₁<θ₂ with the ratio D₁/D₀ of the outer diameter D₁ of the stopper portion on the side of the needle valve to the inner diameter D₀ of the inner chamber of the body becoming 0.6 to 1.1. Consequently, a squeezing force of a suitable level occurs, and the bouncing time of the needle valve at the valve opening time decreases, so that the linearity of the fuel injection characteristics at the injection starting time can be set excellent.

When the valve is closed, the valve disc of the needle valve sits on a valve seat, and, at this time, a delay in the valve closing time after the termination of a valve opening pulse signal decreases since the relation between the angles of inclination θ₁, θ₂ is set to θ₁<θ₂ with the ratio D₁/D₀ of the outer diameter D₁ of the stopper portion to the inner diameter D₀ of the inner chamber of the body set to 0.6 to 1.1 by setting the outer diameter D₁ comparatively large. This enables a speed of an injection operation to be increased to a high level, and a high responsibility of a fuel injection operation to be secured.

### BRIEF DESCRIPTION OF THE DRAWINGS

FIG. 1 is a sectional view of an embodiment of the fuel injection valve according to the present invention:

FIG. 2 is an enlarged sectional view of a free end portion of the same fuel injection valve;

FIG. 3 shows a graph regarding an operation of the fuel injection valve, wherein:

FIG. 3A is a graph showing the relation between a ratio D₁/D₀ of the outer diameter D₁ to the inner diameter D₀ of the inner chamber of the body and the bouncing time at the valve opening time; and

FIG. 3B is a graph showing the relation between the ratio D₁/D₀ of the outer diameter D₁ to the inner diameter D₀ of the inner chamber of the body and a delay in a valve closing operation at the valve closing time;

FIG. 4 shows a graph regarding an operation of the fuel injection valve, wherein:

FIG. 4A is a graph showing the relation between the bouncing time at the valve closing time and an angle of inclination θ₁; and

FIG. 4B is a graph showing the relation between a delay in a valve closing operation at the valve closing time and the angle of inclination θ₁; and

FIG. 5 shows a graph regarding the operation of the fuel injection valve according to the present invention and that of a comparative example, wherein:

FIGS. 5A and 5B are timing charts of a valve opening pulse signal and needle valve opening and closing operations in the comparative example; and

FIG. 5C is a timing chart of a valve opening pulse signal and needle valve opening and closing operations in the embodiment of the present invention.

### DESCRIPTION OF THE PREFERRED EMBODIMENTS

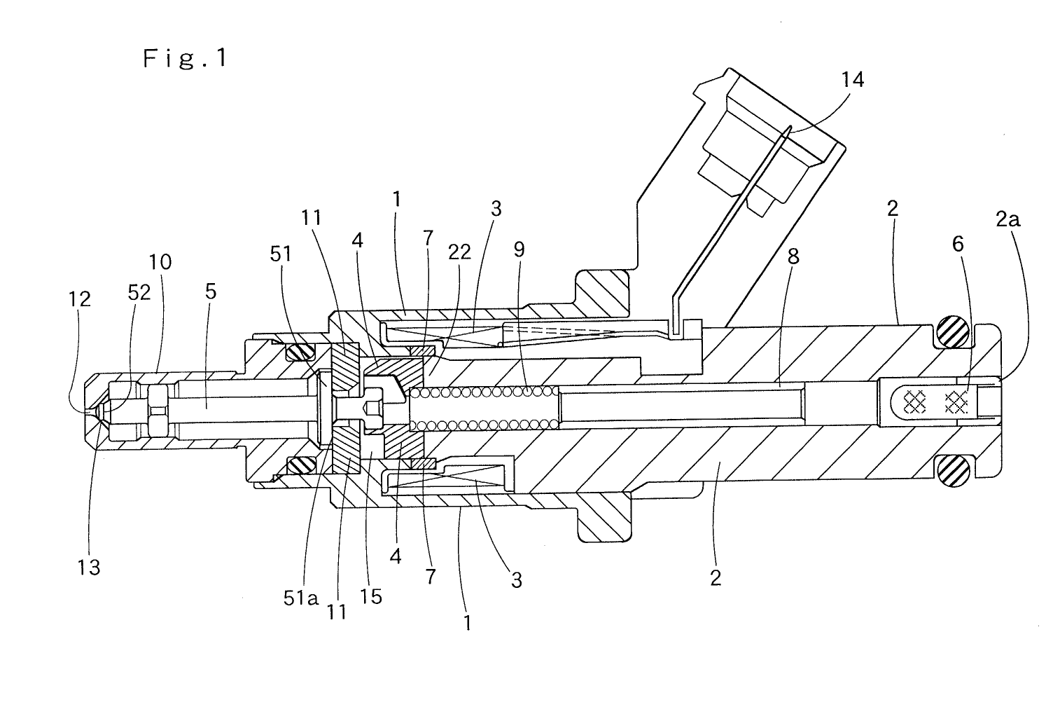

The modes of embodiment of the present invention will now be described with reference to the drawings. FIG. 1 is a sectional view of an electromagnetic fuel injection valve used in an internal combustion engine. This fuel injection valve is basically formed by providing a solenoid 3 in a body 1, inserting movable cores 4 slidably in the interior of an inner chamber 15 of the body 1 which is formed inside the solenoid 3, fixing a needle valve 5 to lower ends of the movable cores 4, fitting a nozzle body 10 around a free end portion of the body 1 so as to enclose the needle valve 5, and fitting and fixing a fuel joint pipe 2 in the interior of a base portion of the body 1. The nozzle body 10 can also be made integral with the body 1.

The fuel joint pipe 2 is provided at its upper end section with a connector portion 2a, in which a filter 6 is inserted. The connector portion 2a is joined to a delivery pipe (not shown). An electric connector 14 is provided on an outer circumferential portion of the body 1 so as to surround an outer circumference of the fuel joint pipe 2, and a terminal of the electric connector 14 is joined to the solenoid 3.

A free end portion of the fuel joint pipe 2 is formed as a fixed core portion 22, which is positioned on the inner side of the solenoid 3. A sleeve 7 is fixed to the outer circumference of a free end section of the fixed core portion 22 so that the sleeve 7 projects slightly toward the side of a nozzle, and base portions of the movable cores 4 are slidably held in the sleeve 7. An insert pipe 8 is inserted in the interior of the fuel joint pipe 2, and a coiled spring 9 is provided between the insert pipe 8 and movable cores 4, the coiled spring 9 urging the movable cores 4 toward free ends thereof, i.e. the needle valve 5 in the closing direction.

The nozzle body 10 is fixed to the free end portion of the body 1 so as to enclose the free end portion of the needle valve 5, and stopper plates 11 are interposed in a base portion, which borders the inner chamber 15 of the body, of the nozzle body 10. A contact surface 51a positioned on a rear side of a flange-like stopper portion 51 of the needle valve 5 engages the stopper plates 11 when the valve is opened. A conical valve disc 52 is formed at a free end of the needle valve 5, and a fuel flow port 12 is formed in a free end portion of the nozzle body 10, a valve seat 13 which the valve disc 52 engages when the valve is closed being formed on a circumference of this flow port 12.

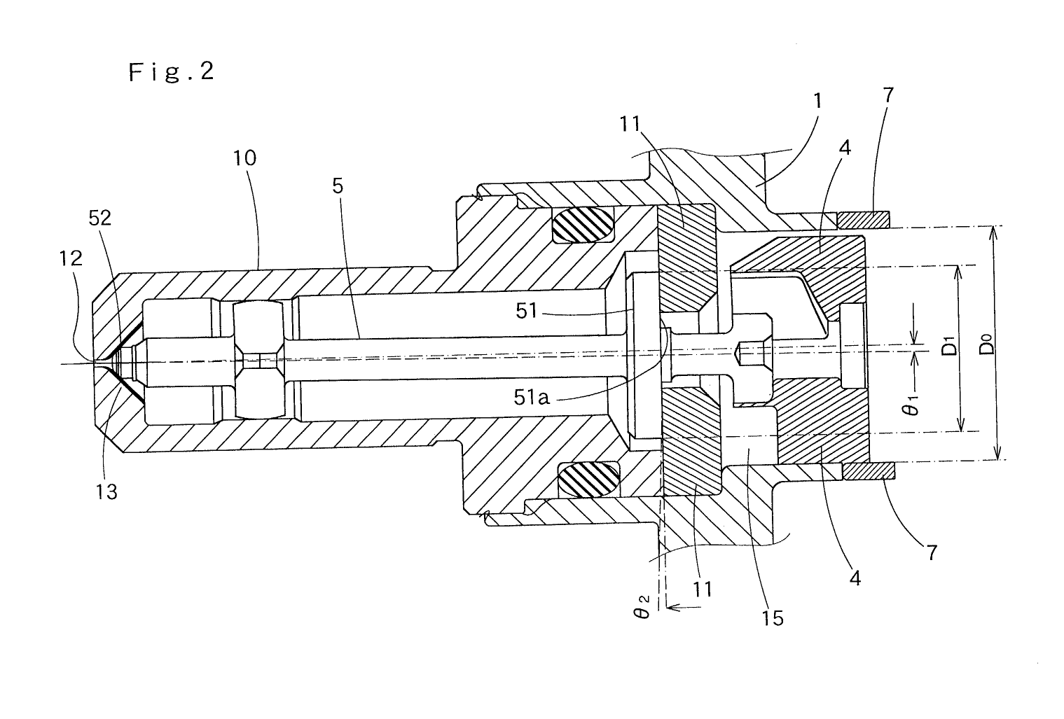

As shown in the enlarged sectional view of FIG. 2, an outer diameter of the movable cores 4 is set slightly smaller as compared with an inner diameter D₀ of the inner chamber 15 of the body to form a clearance around the movable cores, whereby the needle valve 15 is provided so that it can be inclined by an angle of inclination θ₁ with respect to the axis of the body 1. This angle of inclination θ₁ can be set to, for example, around 0.3° to 1.4°. The angle of inclination θ₁ is set smaller than an angle of inclination θ₂ (angle of inclination of the contact surface 51a of the flange-like stopper portion 51 with respect to a perpendicular plane crossing the axis of the needle valve 5 at right angles thereto) which will be described later, i.e., the angle of inclination θ₂ is set larger than the angle of inclination θ₁, whereby the occurrence of an inverse squeeze at the valve opening time is minimized with the bouncing time at the valve opening time reduced.

The contact surface 51a of the flange-like stopper portion 51 of the needle valve 5 is formed into a conically inclined surface, whereby the angle of inclination θ₂ is given between the contact surface 51a and those of the stopper plates 11 with respect to a perpendicular surface crossing the axis of the needle valve 5 at right angles thereto. This angle of inclination θ₂ can be set to, for example, around 0.5° to 1.4°. When it is larger than the angle of inclination θ₁ of the needle valve, and has the relation θ₁<θ₂, excellent results are obtained with respect to the reduction of the occurrence of an inverse squeeze at the valve closing time and that of bouncing at the valve opening time.

The angle of inclination θ₂ can also be set by forming the contact surfaces of the stopper plates 11 of a conically inclined surface. A squeezing force at the valve opening time can also be exerted not between the flange-like stopper portion 51 and stopper plates 11 but between the movable cores 4 and fixed core portion 22 in an engaged state. In this case, the angle of inclination θ₂ may be set by forming the contact surface of the movable core 4 or fixed core portion 22 of a conically inclined surface.

The outer diameter D₁ of the flange-like stopper portion 51 of the needle valve 5 relative to the inner diameter D₀ of the inner chamber 15 of the body constitutes an important factor in the reduction of the occurrence of an inverse squeeze at the valve closing time and that of bouncing at the valve opening time. For example, when the inner diameter D₀ of the inner chamber 15 of the body is 10 mm, the outer diameter D₁ of the flange-like stopper portion 51 can be set to, for example, around 3 mm to 12 mm. When these values are set in a special range, i.e., when the outer diameter D₁ of the flange-like stopper portion 51 is set comparatively large (0.6 to 1.1 in terms of a ratio D₁/D₀ of the outer diameter D₁ to the inner diameter D₀ of the inner chamber 15 of the body), excellent results can be obtained with respect to the reduction of the occurrence of an inverse squeeze at the valve closing time and that of bouncing at the valve opening time.

The fuel injection valve of such a construction is fixed to a suction system of an internal combustion engine, and the electric connector 14 is joined to a control drive circuit (not shown) with the connector portion 2a of the fuel joint pipe 2 joined to a delivery pipe (not shown). When the solenoid 3 is excited with a fuel supplied from the delivery pipe to the fuel joint pipe 2, the movable cores 4 are attracted and moved toward the base portions thereof, at which the movable cores 4 compress the coiled spring 9, and the needle valve 5 is moved in the same direction at the same time, so that the valve disc 52 leaves the valve seat 13 to attain a valve-opened state.

At the valve opening time, the contact surface 51a of the flange-like stopper portion 51 of the needle valve 5 engages the stopper plates 11 to attain a valve-opened state. At this time, the engagement of the contact surface 51a of the flange-like stopper portion 51 with the stopper plates 11 is effected in a linearly contacting state since the relation between the angle of inclination θ₁ and that θ₂ is set to θ₁<θ₂ with the angle of inclination θ₂ set in the range of around 0.5° to 1.4° and with the outer diameter D₁ of the flange-like stopper portion 51 set comparatively large (0.6 to 1.1 in terms of the ratio D₁/D₀ of the outer diameter D₁ to the inner diameter D₀ of the inner chamber 15 of the body). Therefore, a certain level of squeezing force occurs to enable the bouncing time of the needle valve 5 at the valve opening time to be reduced, and the linearity of the fuel injection characteristic at the injection starting time to become excellent.

At the valve closing time, the valve opening pulse signal disappears to cause the solenoid 3 to be deexcited, and the needle valve 5 is moved in the valve closing direction due to a resilient force of the coiled spring 9, the valve disc 52 sitting on the valve seat 13 to close the valve. During this time, when an inverse squeezing force increases to a certain extent, a delay in the valve closing time readily increases.

However, since the relation between the angles of inclination θ₁, θ₂ is set to θ₁<θ₂ with the angle of inclination θ₂ set to around 0.5° to 1.4° and with the outer diameter D₁ of the flange-like stopper portion 51 set comparatively large (0.6 to 1.1 in terms of the ratio D₁/D₀ of the outer diameter D₁ to the inner diameter D₀ of the inner chamber 15 of the body), a delay in the valve closing time after the termination of the valve opening pulse signal is reduced. This enables the injection time to be greatly shortened, an injection operation to be carried out at a high speed, and a fuel injection operation of a high responsibility to be attained.

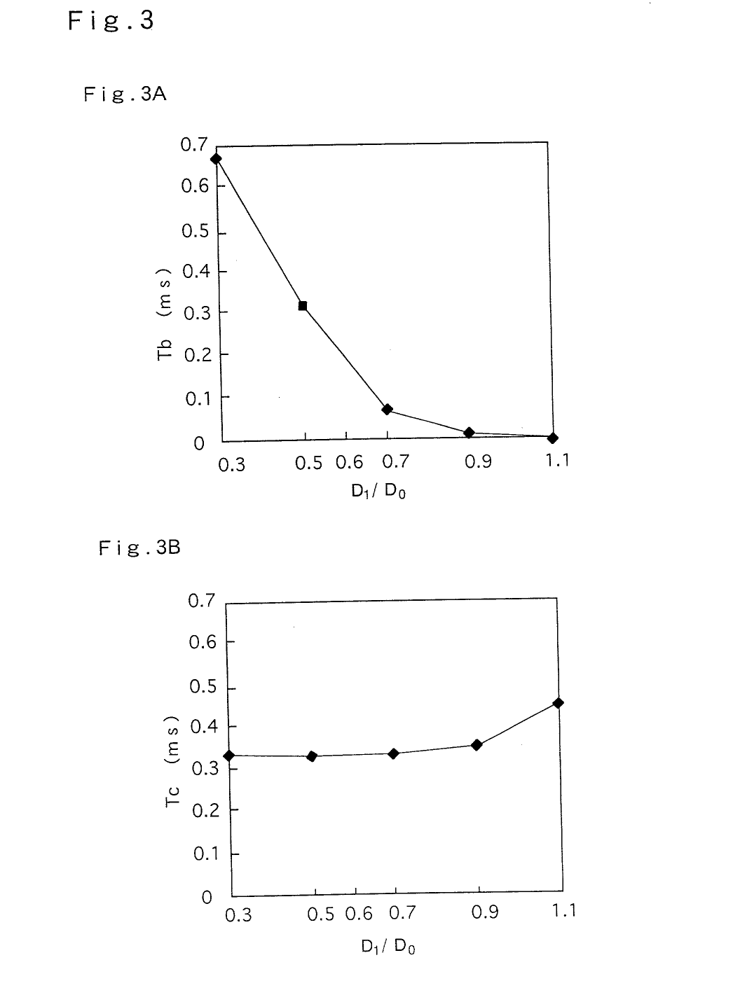

An embodiment and a comparative example carried out so as to ascertain the effect of the present invention will now be described with reference to the graphs of FIGS. 3 to 5. The embodiment and comparative example were practiced by a numerical analysis based on a computer simulation.

In a first embodiment, an outer diameter D₁ of a flange-like stopper portion 51 of a needle valve 5 in a fuel injection valve in which an inner diameter D₀ of an inner chamber 15 of a body was 10 mm was varied within a range of 3 mm to 11 mm, and the time Tb of bouncing which occurred in the needle valve at the valve opening time, and a delay Tc in the valve closing time at the time of closing the valve following the termination of the valve opening pulse signal were measured. In this case, an angle of inclination θ₁ of the needle valve 5 was set to 0.4° with an angle of inclination θ₂ of a contact surface 51a of a flange-like stopper portion 51 set to 0.7°.

FIG. 3A shows a graph of the bouncing time Tb at the valve opening time, and FIG. 3B a graph of the time Tc of a valve closing delay. It is understood from the graphs of FIGS. 3A and 3B that, when the outer diameter D₁ of the flange-like stopper portion 51 is set to 6 mm to 11 mm (0.6 to 1.1 in terms of a ratio D₁/D₀ of the outer diameter D₁ to the inner diameter D₀ of the inner chamber 15 of the body), the bouncing time Tb is shortened to not greater than about 0.2 ms with the delay Tc in the valve closing time shortened to not greater than about 0.45 ms. Namely, it is understood that both the delay in the valve closing time Tc at the time of closing the valve and the bouncing time Tb at the valve opening time are effectively reduced.

When the value of D₁/D₀ is set to be not greater than 0.6, the bouncing time Tb exceeds about 0.2 ms, and the linearity of the fuel injection characteristics at the valve opening time is deteriorated. When the value of D₁/D₀ is set to be greater than 1.1, the delay Tc in the valve closing time increases to exceed about 0.45 ms, and the attainment of the high responsibility of fuel injection is hindered.

In a second embodiment, the outer diameter D₁ of a flange-like stopper portion 51 of a needle valve 5 in a fuel injection valve was set to 5 mm, 7 mm, 9 mm and 11 mm with the angle of inclination θ₂ of a contact surface 51a of the flange-like stopper portion 51 set to 0.2°, 0.7°, 0.9° and 1.4°, and an angle of inclination θ₁ (angle by which the needle valve could be inclined with respect to the axis of a body 1) of the needle valve 5 was varied from 0° to 1.4°. The bouncing time Tb of the needle valve at the valve opening time and a delay Tc in the valve closing time at the time of closing the valve following the termination of a valve opening pulse signal in these cases were measured.

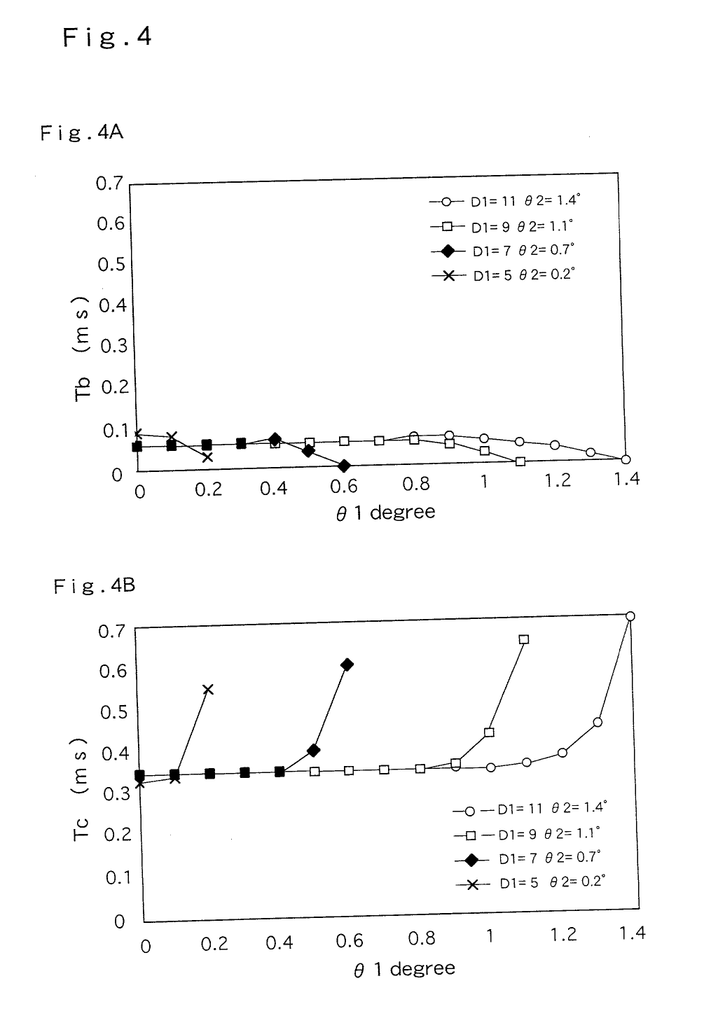

FIG. 4A shows a graph of the bouncing time Tb at the valve opening time, and FIG. 4B a graph of a delay Tc in the valve closing time at the time of closing the valve. It is understood from the graphs of FIGS. 4A and 4B that, when the angle of inclination θ₁ of the needle valve 5 is smaller than that θ₂ of the contact surface 51a of the flange-like stopper portion 51, i.e., when the angle of inclination θ₂ is larger than that θ₁ and has the relation of θ₁<θ₂ and preferably the relation of θ₁≦kθ₂ (k=0.3 to 0.9), the bouncing time Tb at the valve opening time is shortened to not greater than about 0.1 ms; a delay Tc in the valve closing time becomes as short as not longer than about 0.4 ms; and both the delay Tc in the valve closing time at the time of closing the valve and the bouncing time Tb at the valve opening time are effectively reduced.

When the relation between the angle of inclination θ₁ of the needle valve 5 and that θ₂ of the contact surface 51a of the flange-like stopper 51 is set to θ₁≧θ₂, the delay Tc in the valve closing time at the time of closing the valve increases to a level higher than about 0.4 ms, and the attainment of the high responsibility of fuel injection is hindered as is understood from the graph of FIG. 4B.

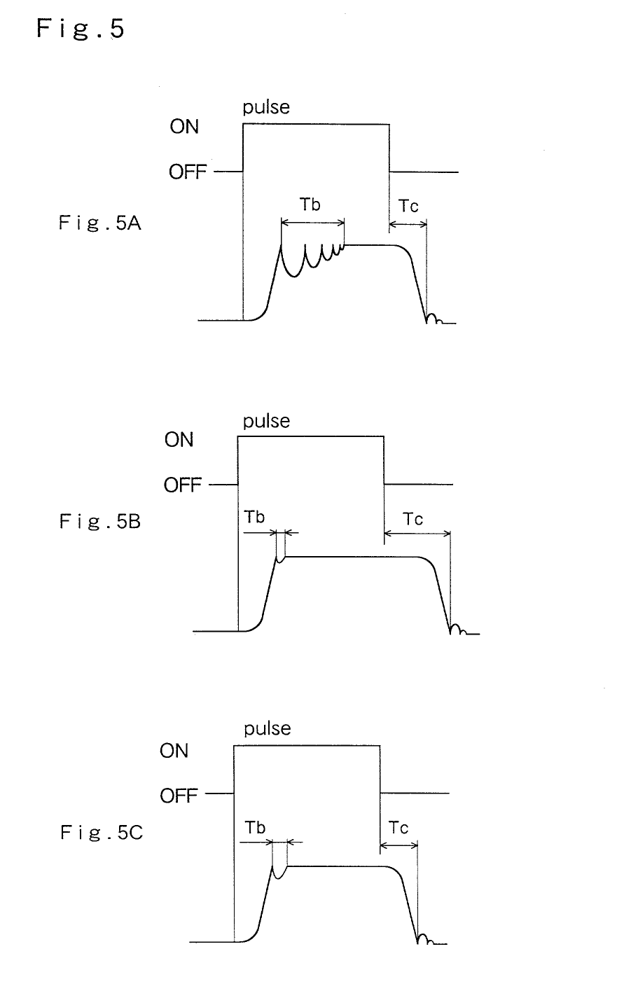

FIG. 5 is a timing chart of valve opening pulse signals and opening and closing operations of needle valves in a simulation conducted as an experiment, wherein FIGS. 5A and 5B show the results of comparative examples, and FIG. 5C those of an embodiment of the present invention.

The timing chart of the comparative example of FIG. 5A shows a waveform of a valve opening pulse signal and the needle valve opening and closing operations in a case where an outer diameter D₁ of a flange-like stopper portion of a needle valve, an angle of inclination θ₁ of the needle valve 5 and an angle of inclination θ₂ of a contact surface 51a of the flange-like stopper portion 51 are set to 4.6 mm, 0.1° and 0.4° respectively.

According to the comparative example of FIG. 5A, it is understood that the bouncing time Tb at the valve opening time is long, which deteriorates the linearity of the fuel injection characteristics. The main cause of this inconvenience resides in the following. The outer diameter D₁ of the flange-like stopper portion is comparatively small. Although the angles of inclination θ₁, θ₂ have the relation of θ₁<θ₂, both of these angles are small.

The timing chart of the comparative example of FIG. 5B shows a waveform of a valve opening pulse signal and the needle valve opening and closing operations in a case where an outer diameter D₁ of a flange-like stopper portion of a needle valve is set to 4.6 mm with an angle of inclination θ₁ of the needle valve 5 and that θ₂ of a contact surface 51a of the flange-like stopper portion 51 set to the same level in a range of 0.1° to 0.4°.

According to the comparative example of FIG. 5B, it is understood that, although the bouncing time Tb at the valve opening time becomes short, a delay Tc in the valve closing time at the time of closing the valve increases greatly to cause the attainment of the high responsibility of the fuel injection to be hindered. The main cause of this inconvenience resides in the relation between the angles of inclination θ₁, θ₂ of θ₁=θ₂ and the comparatively small outer diameter D₁ of the flange-like stopper portion.

The timing chart of the embodiment of FIG. 5c shows a waveform of a valve opening pulse signal and the opening and closing operations of a needle valve in a case where an outer diameter D₁ of a flange-like stopper portion of the needle valve, an angle of inclination θ₁ of the needle valve 5 and an angle of inclination θ₂ of a contact surface 51a of the flange-like stopper portion 51 are set to 9 mm, 0.55° and 1.1° respectively. According to the embodiment of FIG. 5C, the bouncing time Tb at the valve opening time is short, and the linearity of the fuel injection characteristics is improved with a delay Tc in the valve closing time at the time of closing the valve decreased. This enables a fuel injection speed to increase, and fuel injection of a high responsibility to be attained.

In the fuel injection valve according to the present invention described above, the relation between the angles of inclination θ₁, θ₂ is set to θ₁<θ₂, and the outer diameter D₁ of the stopper portion is set comparatively large, i.e., the ratio D₁/D₀ of the outer diameter D₁ to the inner diameter D₀ of the inner chamber of the body is set to 0.6 to 1.1. Therefore, this enables the bouncing time at the valve opening time to be shortened, the linearity of the fuel injection characteristics to be improved, a delay in the valve closing time at the time of closing the valve to be reduced, and the increasing of the speed and responsibility of the fuel injection to be attained.

What is claimed is:

1. A fuel injection valve comprising:
(a) a body provided on the inner side thereof with a portion having an inner diameter D₀,
(b) a needle valve provided in the body so that the needle valve can be moved in the axial direction and inclined by an angle of inclination θ₁ with respect to the axis of the body,
(c) fixed members provided in the body, and
(d) a stopper portion provided on a part of the needle valve, adapted to engage the fixed members when the valve is opened, having an outer diameter D₁, and formed so that an angle of inclination θ₂ set to be larger than that θ₁ with respect to a perpendicular plane crossing the axis of the needle valve at right angles thereto is given between the stopper portion and fixed members, and so that a ratio D₁/D₀ of an outer diameter D₁ of the stopper portion to an inner diameter D₀ of the inside of the body becomes 0.6 to 1.1.

2. A fuel injection valve according to claim 1, wherein the stopper portion is formed of a flange-like stopper portion provided at a base section of the needle valve, the fixed members being formed of stopper plates provided in the inside of the body.

3. A fuel injection valve according to claim 1, wherein the stopper portion is formed of movable cores fixed to a base section of the needle valve, the fixed members being formed of a fixed core provided in the inside of the body.

4. A fuel injection valve according to claim 1, wherein the angle of inclination θ₂ is set to 0.5° to 1.4°.

5. A fuel injection valve according to claim 2, wherein the angle of inclination θ₂ with respect to a perpendicular plane crossing the axis of the needle valve at right angles is made by forming the contact surface of the flange-like stopper portion of the needle valve of a conically inclined surface.

6. A fuel injection valve according to claim 2, wherein the angle of inclination θ₂ with respect to a perpendicular plane crossing the axis of the needle valve at right angles thereto is made by forming contact surfaces of the stopper plates of conically inclined surfaces.
